(19) United States
(12) Patent Application Publication
(10) Pub. No.: US 2020/0135012 A1
(43) Pub. Date: Apr. 30, 2020

(54) MECHANISMS FOR SECURING GOODS AT A POINT-OF-SALE

(71) Applicant: Christopher Andrew Nordstrom, Dedham, MA (US)

(72) Inventor: Christopher Andrew Nordstrom, Dedham, MA (US)

(21) Appl. No.: 16/733,030

(22) Filed: Jan. 2, 2020

Related U.S. Application Data
(63) Continuation of application No. 13/682,065, filed on Nov. 20, 2012, now abandoned.
(60) Provisional application No. 61/562,058, filed on Nov. 21, 2011.

(51) Int. Cl. G08C 19/00; G06Q 20/40; G06Q 20/32; G06Q 20/18; G07F 11/00; G07F 9/02

(52) U.S. Cl. CPC G08C 19/00; G06Q 20/40; G06Q 20/3278; G07F 9/026; G07F 11/002; G06Q 20/3276; G06Q 20/18

(57) ABSTRACT

Mechanisms for securing goods at a point-of-sale. A server device receives data identifying an item from a mobile device via a network. The server device identifies a security device that secures the item. The server device receives data from the mobile device indicating a purchase of the item. In response to the receipt of the data, the server device sends data to the security device directing the security device to unsecure the item.

### RELATED APPLICATIONS

This application is a continuation of co-pending U.S. patent application Ser. No. 13/682,065, filed on Nov. 20, 2012, entitled “MECHANISMS FOR SECURING GOODS AT A POINT-OF-SALE,” which claims the benefit of U.S. Provisional Application No. 61/562,058, filed Nov. 21, 2011, entitled “THEFT DETERRENT SYSTEMS FOR MOBILE DEVICE-BASED POINT OF SALE (POS) TRANSACTIONS,” the disclosures of each of which are hereby incorporated herein by reference in their entireties.

### TECHNICAL FIELD

The embodiments relate to securing items, such as goods, in the context of a purchase transaction.

### BACKGROUND

Self-checkout is increasingly popular because it can benefit both the consumer and the seller. For the seller, self-checkout reduces labor costs. Moreover, because information about products is now readily available on the Internet, many consumers no longer require an educated retail work force and the unavailability of retail workers at a point-of-sale may therefore cause little or no dissatisfaction among consumers. The costs saved from the reduction of labor may allow the installation of multiple self-checkout lanes, resulting in shorter lines for the consumer.

Self-checkout, however, suffers from certain drawbacks. Self-checkout is frequently implemented via one or more unmanned self-checkout registers, or lanes, that may take up a substantial amount of space. Many retailers are moving toward smaller stores in order to compete with online retailers who do not have the overhead associated with physical stores. Self-checkout also often makes theft easier. Since the entire transaction may be consummated without oversight of an employee of the store, thieves may find such situations ripe with opportunity.

### SUMMARY

The embodiments relate to mechanisms for securing goods at a point-of-sale until such goods are purchased. In one embodiment, a consumer, while in a retail store for example, uses a mobile device to receive data that uniquely identifies an item that is in proximity to the mobile device and that is secured by a security device. The mobile device may comprise, for example, the consumer's smart phone. The mobile device may receive the data, for example, via a wireless signal, such as a WiFi™ signal, via scanning a radio frequency identification (RFID) tag, or by entering into the mobile device an identifier that is on or in proximity to the item. The mobile device communicates the data to a server device that is communicatively coupled to the security device. The user may ultimately decide to consummate the transaction by purchasing the item. The mobile device provides transaction consummation data to the server device for release of the security device. The server device sends data to the security device directing the security device to unsecure the item. The consumer may then leave the retail store with the purchased item. Thus, among other advantages, such embodiment facilitates secure transactions by ensuring that a good remains secured until a consumer pays for the good.

In another embodiment, a server device receives data from a mobile device over a network that identifies an item. The server device identifies a security device that secures the item. The server device determines that payment for the good has been authorized. The server device sends data to the security device directing the security device to unsecure the item.

The security device may comprise any mechanism having a secured mode and an unsecured mode, and being capable of communicating with the server device. While in secured mode, certain actions by a consumer may result in the activation of an alarm, or otherwise inhibit access to the item by the consumer. While in unsecured mode, the consumer may depart the retail location with the item.

In one embodiment, the security device comprises a releasable barrier for securing an item and a communications interface configured to communicate with a network. A processor is coupled to the communications interface and the releasable barrier. The processor is configured to receive, via the communications interface, data from a server device directing the security device to release the releasable barrier to unsecure the item. In response to the data, the security device releases the releasable barrier. The releasable barrier may comprise a physical barrier or a virtual barrier. A physical barrier may comprise any suitable releasable mechanism, such as a door, a flap, or the like. The virtual barrier may comprise any mechanism capable of detecting either an entry of an object into an interior of the security device, such as a hand, or the removal of the item from the interior of the security device. The virtual barrier may comprise, for example, an electromagnetic field that spans an opening of the security device. If the electromagnetic field is interrupted while the security device is in the secured mode, the security device may activate an alarm.

In other embodiments, the server device may receive from a mobile device data identifying a plurality of different items. The server device may identify a corresponding plurality of security devices, each security device securing a particular item of the plurality of items. The server device receives from the mobile device data indicating a purchase of the plurality of items. The server device may then receive, from the mobile device, a consecutive plurality of release messages, each release message identifying a different item of the plurality of items. In response to receiving each release message, the server device sends data to the security device that corresponds to the different item to unsecure the different item. In this manner, a consumer may purchase multiple items which are located at various different locations within a store, and then, at the desired pace of the consumer, consecutively cause each security device to unsecure the corresponding item, to ensure that the item remains secured until the consumer is in proximity of the item.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a flowchart illustrating a process according to one embodiment;

FIG. 2 is a block diagram illustrating configuration data according to one embodiment;

FIG. 3 is a block diagram of a system in which embodiments may be practiced;

FIG. 4 is a block diagram of a system according to another embodiment;

FIG. 5 is a diagram of a system illustrating a perspective view of a security device according to one embodiment;

FIG. 6 is a diagram of a system illustrating a perspective view of a security device according to another embodiment;

FIG. 7 is a block diagram of a system according to another embodiment;

FIG. 8 is a block diagram of the system illustrated in FIG. 7 after a point in time at which a user has purchased multiple items;

FIG. 9 is a flowchart of a method for releasing items according to one embodiment;

FIG. 10 is a block diagram illustrating a server device according to one embodiment; and

FIG. 11 is a block diagram illustrating a mobile device according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The embodiments relate to mechanisms for securing items at a point-of-sale until such items are purchased. For purposes of illustration, the embodiments will be discussed in the context of a retail store and the purchase of one or more items by a consumer, but the embodiments are not limited to a retail store context and have applicability in any context wherein it is desired to ensure that an item remains secure until authorization to remove such item has been granted.

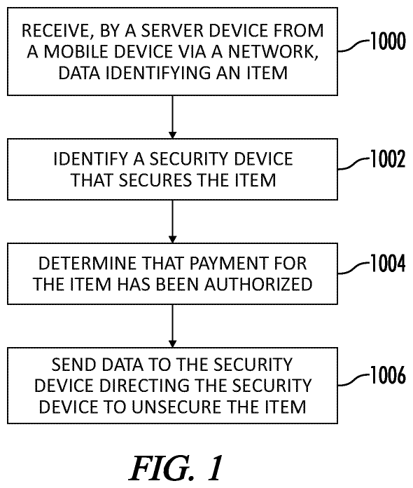

In a retail context, the embodiments, among other advantages, facilitate secure self-checkout by consumers, reducing the possibility of theft of items, and facilitating relatively rapid purchase transactions by consumers, even in the absence of a retail work force. Prior to discussing an example architecture suitable for implementing embodiments, a process according to one embodiment will be discussed with reference to FIG. 1. As illustrated in FIG. 1, in one embodiment, a server device receives, from a mobile device via a network, data identifying an item (block 1000). For example, the mobile device may belong to a user, such as a consumer, who is in physical proximity of an item for sale at a retail establishment. The mobile device obtains an identifier of the item, and sends the identifier to the server device. The server device, in one embodiment, may be managed or otherwise controlled by the retail establishment. The server device identifies a security device that secures the item (block 1002). The server device determines that payment for the item has been authorized (block 1004). The server device sends data to the security device directing the security device to unsecure the item (block 1006). The user may then physically remove the item from the retail establishment. Thus, the user, even perhaps without oversight of an employee of the retail establishment, is able to consummate a purchase transaction in a secure manner, and the retail establishment is able to ensure that the item was not removed from the establishment until payment for the item has been authorized, with little or no labor costs associated with the transaction.

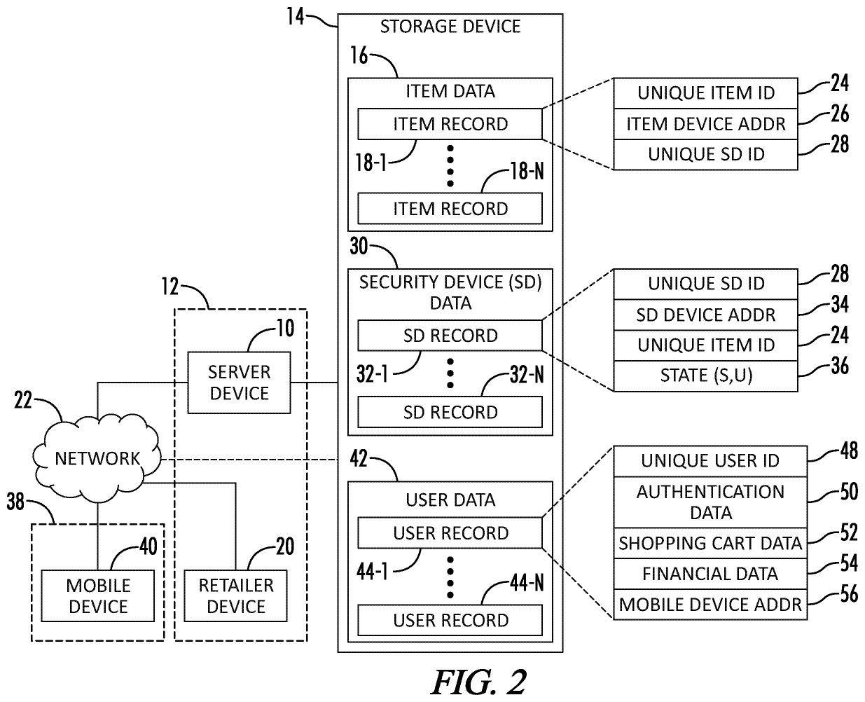

FIG. 2 is a block diagram illustrating configuration data according to one embodiment. FIG. 2 will be used to discuss a configuration process, according to one embodiment, which may occur prior to a purchase transaction. A server device 10 may be owned, controlled, or otherwise managed by an entity that desires to secure items prior to the purchase of such items. For purposes of illustration, such entity will be referred to herein as a retailer 12, but the embodiments are not limited to a retail context. For purposes of simplicity and illustration, functionality will be attributed herein to the server device 10 that could be implemented by a number of different computing devices that are communicatively coupled to one another. Thus, the retailer 12 may own, control, or otherwise manage multiple different devices that collectively implement the functionality described herein as being associated with the server device 10. The phrase “communicatively coupled” as used herein refers to an ability to communicate with one another substantially in real-time. Thus, two devices that are in relative close physical proximity to one another and coupled to one another without a network may be considered to be communicatively coupled to one another, and two devices that are physically separated by, for example, thousands of miles, and communicate with one another via multiple different networks are also considered to be communicatively coupled to one another.

The server device 10 is integrated with or communicatively coupled to a storage device 14. For purposes of simplicity, a single storage device 14 is shown, but the data described herein may be stored on multiple different storage devices 14. Initially, the retailer 12 may configure the storage device 14 to contain item data 16 which includes information regarding a plurality of different items that the retailer 12 offers for sale. The item data 16 may be part of an inventory control system (not illustrated) managed by the retailer 12, may be coupled to such an inventory control system, or may be separate from an inventory control system. The item data 16 includes a plurality of item records 18-1-18-N (generally, item records 18), each of which contains data about a particular item. Such information may be manually entered, by a retailer device 20 for example, that is communicatively coupled to the server device 10, and/or the storage device 14, in one embodiment via a network 22 for example.

Each item record 18 may include fields for storing data associated with a particular item. Representative data may include a unique item identifier (ID) 24 that uniquely identifies the particular item. In some embodiments, as discussed in greater detail herein, the item may contain, be affixed to, or otherwise be in proximity to, an item device that is communicatively coupled to the server device 10. In such embodiments, the item record 18 may include an item device address 26 that may be used by the server device 10 to communicate with the item device. The item record 18 may also include a unique security device ID 28 that identifies a security device that secures the particular item. It will be appreciated that each item record 18 may contain additional information for each respective item, as desired or appropriate.

The retailer 12 may also configure the storage device 14 to contain security device data 30, which includes information regarding a plurality of different security devices that are used to secure respective items. The security device data 30 includes a plurality of security device records 32-1-32-N (generally, security device records 32), each of which contains data about a particular security device. Again, such information in one embodiment may, for example, be manually entered via the retailer device 20, or via any other suitable mechanism.

Each security device record 32 includes fields for storing data associated with a particular security device. Representative data may include the unique security device ID 28 that uniquely identifies a particular security device. The security device record 32 may also include a security device address 34 that facilitates communication with the security device by, for example, the server device 10. The security device record 32 may also include the unique item ID 24 of the respective, or corresponding, item that is being secured. The security device record 32 may maintain a state 36 that indicates whether at a particular point in time the security device is in a secured mode (“S”), or an unsecured mode (“U”).

While for purposes of illustration the storage device 14 has been illustrated as including certain data capable of identifying relationships between items and security devices, it will be appreciated that the embodiments are not limited to any particular collection or organization of data, and any mechanism capable of identifying the relationship between a particular item and the security device used to secure such item may be used. Any suitable data structure or structures may be used to store such data, such as a database, or the like.

In some embodiments, a consumer, such as a user 38, may “pre-register” with the retailer 12. The user 38 owns, manages, or otherwise controls a mobile device 40. The mobile device 40 may comprise, for example, a smart phone. The user 38 may, in one embodiment, download onto the mobile device 40 an application or program module provided by the retailer 12 to implement some or all of the functionality described herein. In other embodiments, the functionality may be implemented, at least in part, via browser software that interactively and substantially in real-time downloads data, such as HTML web pages or Java modules, from the server device 10 or from some other device managed or controlled by the retailer 12.

The user 38, via the mobile device 40 or from some other computing device, may provide information that is stored in the storage device 14. Such data may be referred to collectively as user data 42. The user data 42 may include user records 44-1-44-N (generally, user records 44), wherein each user record 44 corresponds to a respective registered user 38. Each user record 44 includes fields for storing data associated with a particular registered user 38. While the mobile device 40 is illustrated as being coupled to the server device 10 and the storage device 14 by the network 22, it will be appreciated that the mobile device 40 may communicate with the server device 10 or storage device 14 by any suitable network or combination of networks, including, for example, a wide area network such as a cellular data network.

Representative data may include a unique user ID 48. Authentication data 50 may be used by the server device 10 to authenticate the user 38, to ensure the mobile device 40 is being used by the appropriate user 38. Shopping cart data 52 may store information identifying one or more items that the user 38 has indicated an intent to purchase. Financial data 54 may include information that allows the server device 10 to obtain funds for purchases by the user 38, or otherwise determine or ensure that payment for an item has been authorized. For example, financial data 54 may comprise a default credit card designated by the user 38 to be used for purchasing items. In other embodiments, the user 38 may deposit an amount of money into an account maintained by the retailer 12, and the financial data 54 may contain information identifying the particular account. The user 38 may be permitted to purchase items up to the amount of funds remaining in the account. In still other embodiments, a financial intermediary may be used to provide funds to the retailer 12, and financial data 54 may not be necessary. The user record 44 may also include a mobile device address 56 of the mobile device 40 that is associated with the user 38, such as a telephone number or internet protocol address associated with the mobile device 40. In other embodiments, registration by the user 38 may not be necessary, or may be performed at the time of purchase of an item.

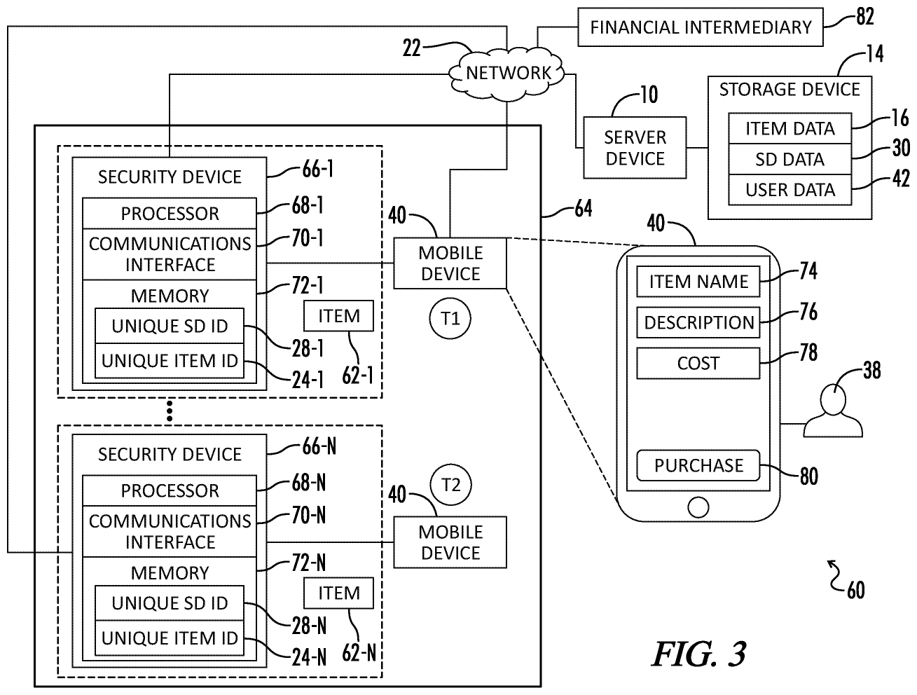

FIG. 3 is a block diagram of a system 60 in which embodiments may be practiced. The system 60 includes the server device 10 and the storage device 14. Items 62-1 and 62-N (generally, items 62) are located within a retail location 64 associated with the retailer 12 (FIG. 2). While only two items 62 are illustrated, it will be appreciated that the retail location 64 may contain any number of items 62 for purchase. The items 62-1-62-N are each secured by a corresponding, sometimes referred to as a respective, security device 66-1-66-N (generally, security devices 66). The security devices 66 have a secured mode, and an unsecured mode, and when in the secured mode, secure the corresponding item 62 by either preventing physical access to the item 62 by the user 38, or by prohibiting certain actions with respect to the item 62, and activating an alarm upon detecting the occurrence of such a prohibited action. For example, the security device 66-1 may comprise a container having a releasable barrier, such as a door. At least a portion of the container may be transparent, such as a wall, or portion thereof manufactured from a transparent material, such as glass, or plexiglass. The item 62-1 may be enclosed within the container, and may be perceivable by the user 38 through the transparent portion of the container.

In one embodiment, the security device 66-1 includes a processor 68-1 and a communications interface 70-1. The processor 68-1 may be configured to implement functionality described herein. The communications interface 70-1 may facilitate communications with one or more devices via one or more communication technologies, including, for example, wired Internet, wireless Internet (e.g., WiFi™), Bluetooth®, Zigbee®, or the like. Thus, the communications interface 70-1 may include one or more transceivers, each of which is designed to communicate via a particular communication technology. In one embodiment, the communications interface 70-1 facilitates communication with the server device 10 via the network 22, and thus is communicatively coupled with the server device 10. The network 22 may comprise any one or more of public and/or private networks, including local area networks, wide area networks, the Internet, or any combination thereof. In one embodiment, the server device 10 may be in the same physical location as the retail location 64. In other embodiments, the server device 10 may be located remotely from the retail location 64. The communications interface 70-1 may also facilitate communications with the mobile device 40 via, for example, a wireless technology such as WiFi™, Bluetooth®, Zigbee®, or the like.

The security device 66-1 also includes a memory 72-1 in which information may be stored, including, for example, a unique security device ID 28-1 that uniquely identifies the security device 66-1, and a unique item ID 24-1 that uniquely identifies the item 62-1.

The security device 66-N may be configured substantially similarly to the security device 66-1, and include a processor 68-N, communications interface 70-N, and memory 72-N. The security device 66-N may be adjacent to or otherwise relatively near the security device 66-1, or may be separated by a relatively large physical distance, such as hundreds of feet from the security device 66-1, within the retail location 64.

In practice, in an embodiment where the security devices 66 comprise containers, an employee of the retail location 64, during an inventory stocking process, may insert the item 62-1 into the security device 66-1, and then place the security device 66-1 into secured mode, such as by closing the door to the container. Doing so may cause the security device 66-1 to communicate information to the server device 10 indicating that the security device 66-1 is in secured mode. Alternatively, the employee may direct the server device 10 to put the security device 66-1 into secured mode, and the server device 10 may send data to the security device 66-1 directing the security device 66-1 to enter secured mode. In this embodiment, while in secured mode, the door to the container cannot be opened.

The employee also programs the security device 66-1 with the unique item ID 24-1. This may be accomplished via any suitable mechanism. In one embodiment, the security device 66-1 may include a user interface, such as a touchscreen, which enables the employee to directly program the security device 66-1 with the unique item ID 24-1. In another embodiment, the security device 66-1 may communicate wirelessly with a handheld device carried by the employee, and via which the employee may program the security device 66-1 with the unique item ID 24-1. In such embodiments, the security device 66-1 may communicate the unique item ID 24-1 and the unique security device ID 28-1 to the server device 10 for storing in the storage device 14.

In yet another embodiment, the employee may provide the unique item ID 24-1 and the unique security device ID 28-1 to the server device 10 for storing in the storage device 14, and the server device 10 may communicate the unique item ID 24-1 to the security device 66-1. The server device 10 also updates the appropriate item record 18 and security device record 32 with such information.

This same general process may be carried out by the employee with any number of different items 62 and corresponding security devices 66, including the item 62-N and the security device 66-N. This process may also be a relatively continual process wherein an employee continually, over the course of a business day, re-stocks security devices 66 with corresponding items 62 as items 62 are purchased by users 38.

Thus, in one embodiment, after the security device 66-1 has been stocked with the item 62-1, the storage device 14 contains an item record 18 that corresponds to the item 62-1 and indicates the item 62-1 is being secured by the security device 66-1. The storage device 14 also contains a security device record 32 that indicates the security device 66-1 is securing the item 62-1.

Assume that the user 38 and mobile device 40 come within proximity of the security device 66-1 and the item 62-1. Proximity in this context generally means within visual distance of the item 62-1, and may comprise, but is not limited to, for example, within five feet of the item 62-1. In one embodiment, the user 38 may initiate an application module on the mobile device 40 that was provided by the retailer 12 for the purpose of facilitating purchase transactions in retail locations 64 of the retailer 12. The mobile device 40 receives data that uniquely identifies the item 62-1, such as the unique item ID 24-1.

In one embodiment, the mobile device 40 may receive the unique item ID 24-1 via manual entry of the unique item ID 24-1 by the user 38. In this embodiment, the unique item ID 24-1 may be visually presented to the user 38 in relatively close physical proximity to the item 62-1, such as on or by the security device 66-1, or on the item 62-1. The user 38 may then enter the unique item ID 24-1 into the mobile device 40 via a user interface, such as a touchscreen, of the mobile device 40.

In other embodiments, the mobile device 40 may receive the unique item ID 24-1 wirelessly. For example, the security device 66-1 may wirelessly communicate the unique item ID 24-1 to the mobile device 40 via, for example, WiFi™, Bluetooth® or the like. The security device 66-1 and the mobile device 40 may precede this communication with one or more hand-shake transactions to establish a session between the security device 66-1 and the mobile device 40 to limit the transmission of the unique item ID 24-1 to the mobile device 40.

In other embodiments, the mobile device 40 may include a radio frequency identification (RFID) or near-field communication (NFC) reader, and the unique item ID 24-1 may be read from a corresponding RFID or NFC tag placed in proximity to the item 62-1. In yet another embodiment, the mobile device 40 may use an integrated camera to capture a label, barcode, QR code, or the like, which contains the unique item ID 24-1.

The mobile device may use the unique item ID 24-1 to access a local or remote storage, or processing device, obtain information regarding the item 62-1, and present such information on the mobile device 40 to the user 38. Alternatively, the security device 66-1 may provide such information to the mobile device 40. Such information may include an item name 74, a description 76, and a cost 78. It will be apparent that such information is merely representative, and any desired information may be provided to the user 38.

Assume at a time T1 that the user 38 decides to purchase the item 62-1, and indicates such desire via the mobile device 40, by, for example, activating a purchase control 80. The mobile device 40 communicates the unique item ID 24-1 to the server device 10, and transaction consummation data to the server device 10. The mobile device 40 may communicate with the server device 10, in one embodiment, via a completely different network 22 than that used by the security device 66-1 to communicate with the server device 10. For example, the mobile device 40 may communicate with the server device 10 at least in part via a wide area network, such as a cellular data network provided by a service provider which provides cellular data service to the mobile device 40.

The transaction consummation data comprises data that indicates a desire to purchase the item 62-1. The actual mechanism for authorizing payment to the retailer 12 may comprise any mechanism that the retailer 12 deems suitable to ensure payment for purchased items 62. In one embodiment, the user 38 may have funds already deposited with the retailer 12, and the transaction consummation data may direct the server device 10 to deduct the appropriate cost of the item 62-1 from the account. In another embodiment, a financial intermediary 82, such as a third-party payment mechanism, such as PayPal®, or a credit card institution, may be used, and the transaction consummation data initiates a transaction involving the financial intermediary 82, which may involve the user 38 entering appropriate authorization information to the financial intermediary 82 sufficient to result in an approval of the transaction. In yet another embodiment, the user 38 may have designated a default financial intermediary 82 for use in purchase transactions, and in response to receiving the transaction consummation data, the server device 10 automatically initiates a transaction with the financial intermediary 82 to authorize payment for the item 62-1.

After the server device 10 determines that payment for the item 62-1 has been authorized, the server device 10 sends data to the security device 66-1 to unsecure the item 62-1. In an embodiment wherein the releasable barrier comprises a door, the security device 66-1 unsecures the door. An indication, or combination of indications, that the barrier has been released may be provided to the user 38. For example, the door may wholly or partially automatically open. A visual indicator, such as a green light, may activate, indicating that the user 38 may now open the door. An audible indicator may be initiated, such as a suitable sound, word, or sequence of words. Any other suitable indication or indications may be used to signal to the user 38 that the item 62-1 may now be taken from the retail location 64. In some embodiments, the user 38 may provide authorization to the retailer 12 that a single selection of the purchase control 80 is authorization to charge a predetermined credit card, such that simply selecting the purchase control 80 results in the security device 66-1 unsecuring the door. At a time T2, the user 38 may undergo a substantially similar process to purchase the item 62-N.

In some embodiments, prior to being able to purchase an item 62, the user 38 may first have to authenticate herself to the retailer 12. Authentication may involve the user 38 providing data to the mobile device 40, which in turn provides such data to the server device 10. The server device 10 may then compare such data to predetermined authentication data 50 stored in the storage device 14 that corresponds to the user 38, and either authenticate the user 38, or not authenticate the user 38. The server device 10 communicates whether or not the user 38 has been authenticated to the mobile device 40.

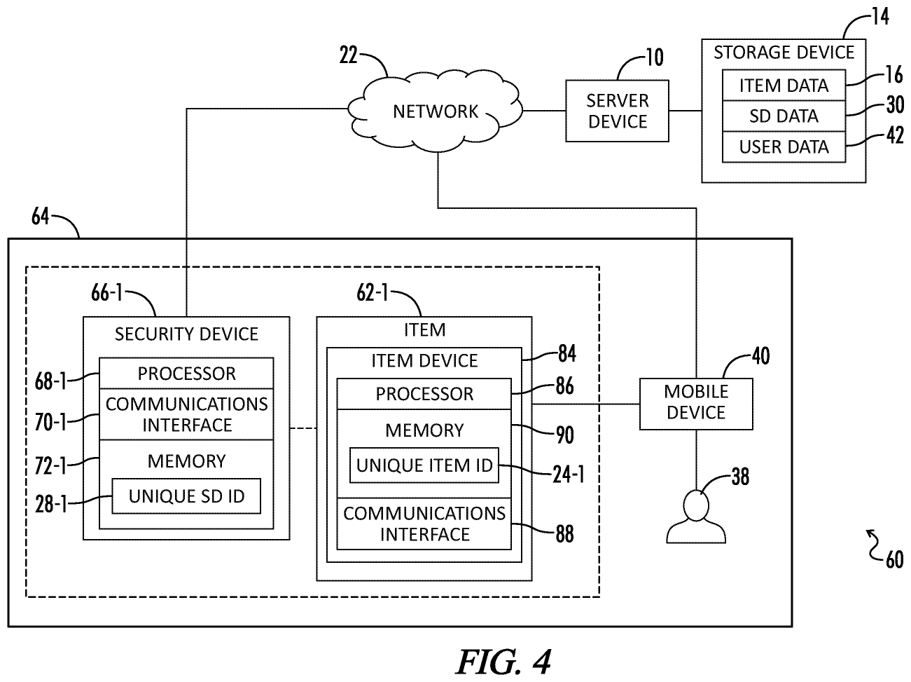

FIG. 4 is a block diagram of the system 60 according to another embodiment. In this embodiment, each item 62 may be associated with an item device 84. The item device 84 may include a processor 86 and a communications interface 88 for facilitating communications with one or more devices via one or more communication technologies, including, for example, wired Internet, wireless Internet (e.g., WiFi™), Bluetooth®, Zigbee®, or the like. The item device 84 may have a memory 90 that is preprogrammed, in a manner similar to that described above with regard to programming the security device 66-1 with reference to FIG. 3, with the unique item ID 24-1 that uniquely identifies the item 62-1. In other embodiments, the item device 84 may not include the processor 86, and may operate without a direct power source, such as via electromagnetic induction, as may be utilized, for example, with certain types of RFID tags.

The item device 84 may be affixed to the item 62-1, or may simply be within visual proximity of the item 62-1. In this embodiment, the item device 84 may communicate with the mobile device and provide information to the mobile device 40 such as, for example, the unique item ID 24-1, and other information, such as item name, description, and cost of the item 62-1, or any other suitable information. In this embodiment, the security device 66-1 optionally may have no data identifying which particular item 62 is being secured by the security device 66-1, although such information is still maintained in the storage device 14, as described previously. In other embodiments, the security device 66-1 may store the unique item ID 24-1 in the memory 72-1, and the item device 84 may store the unique security device ID 28-1 in the memory 90.

In some embodiments, the item device 84 may be affixed to, or otherwise physically coupled to the item 62-1. In such embodiments, the security device 66-1 may secure the item 62-1 by prohibiting certain actions with respect to the item 62-1. For example, the security device 66-1 may be able to communicate with the item device 84, and determine a location of the item device 84 with respect to the security device 66-1. The user 38 may be permitted to physically manipulate the item 62-1, or move the item 62-1 a predetermined distance, but if the item 62-1 is moved beyond the predetermined distance while the security device 66-1 is in secured mode, the security device 66-1 may activate an alarm. The alarm may be manifested as an audible and/or visual alarm, or may comprise automatic communications with other devices, such as door locking mechanisms, operator consoles, or the like. After the user 38 has purchased the item 62-1, as discussed above with regard to FIG. 3, for example, the server device 10 communicates data to the security device 66-1 to unsecure the item 62-1.

In another embodiment, the security device 66-1 may be located in a location, such as an exit of the retail location 64, where it will be necessary for the user 38 to pass within relatively close physical proximity to the security device 66-1 in order to exit the store. In such embodiment, the security device 66-1 may wirelessly detect the presence of the item device 84 as the item device 84 is in such relatively close physical proximity. If the security device 66-1 detects the presence of the item device 84 and the security device 66-1 has not received a direction from the server device 10 to release the item 62-1, the security device 66-1 may activate an alarm.

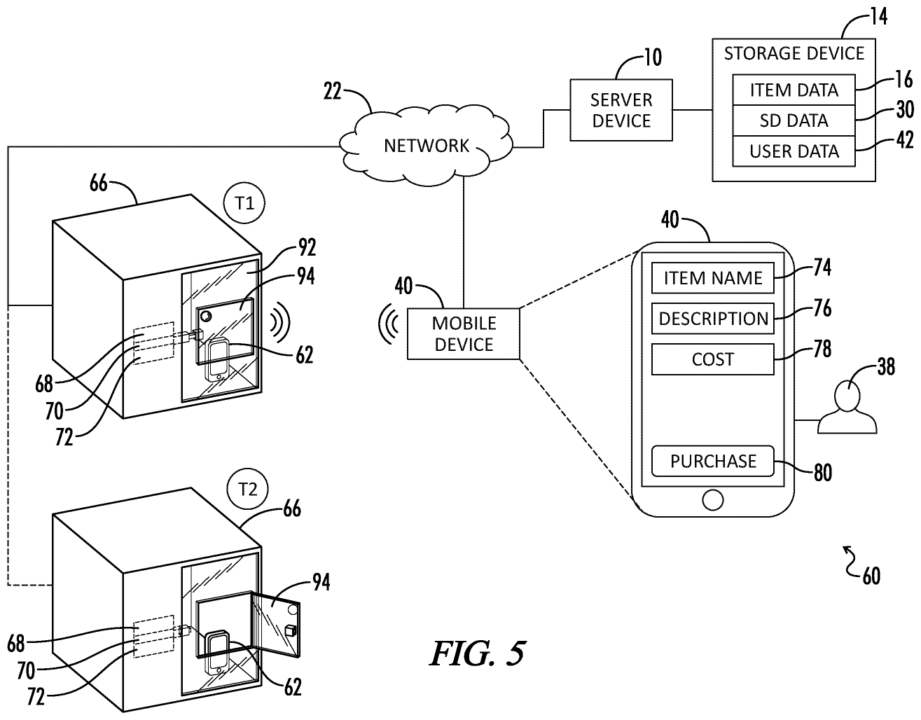

FIG. 5 is a diagram of the system 60 illustrating a perspective view of a security device 66 according to one embodiment. In this embodiment, the security device 66 comprises a container that includes a transparent portion 92 which enables the user 38 to view a particular item 62. Assume that at time T1 the user 38, similar to the process as described with respect to FIG. 3, purchases the item 62. The server device 10 communicates data to the security device 66 to unsecure the item 62. In response, at time T2, the security device 66 releases a door 94 of the container. The user 38 may reach into the security device 66, and take physical possession of the item 62.

While only a single security device 66 is illustrated, any number of security devices 66 may be used for securing a corresponding plurality of items 62. In some embodiments, security devices 66 may be arranged in a matrix fashion to permit a user 38 to purchase a number of different items 62 within close physical proximity of one another. For example, assume that the security device 66 has an exterior dimension of 10 inches by 10 inches. Fifty columns of six security devices 66 each may be stacked adjacent to one another, to form a three hundred security device 66 matrix via which the retailer 12 (FIG. 2) may offer three hundred items 62 for sale.

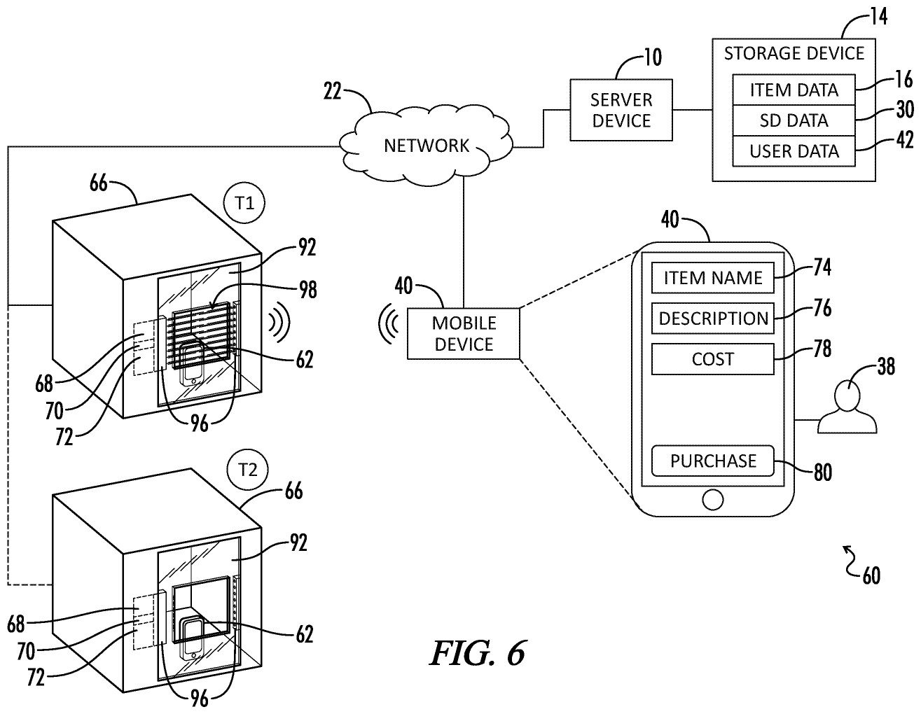

FIG. 6 is a diagram of the system 60 illustrating a perspective view of a security device 66 according to another embodiment. In this embodiment, the security device 66 again comprises a container that includes a transparent portion 92 which enables the user 38 to view the item 62. However, rather than a physical door, the security device 66 includes circuitry 96 capable of generating an electromagnetic field 98, such as an infrared electromagnetic field 98, and detecting when an object breaks the electromagnetic field 98. If, while the security device 66 is in secured mode, the user 38 attempts to reach into the security device 66, the breaking of the electromagnetic field 98 is detected and the security device 66 activates an alarm.

Assume that at time T1 the user 38, similar to the process as described with respect to FIG. 3, purchases the item 62. The server device 10 communicates data to the security device 66 to unsecure the item 62. In response, at time T2, the security device 66 turns off the electromagnetic field 98 and enters unsecured mode, thereby allowing the user 38 to reach into the security device 66, and take physical possession of the item 62.

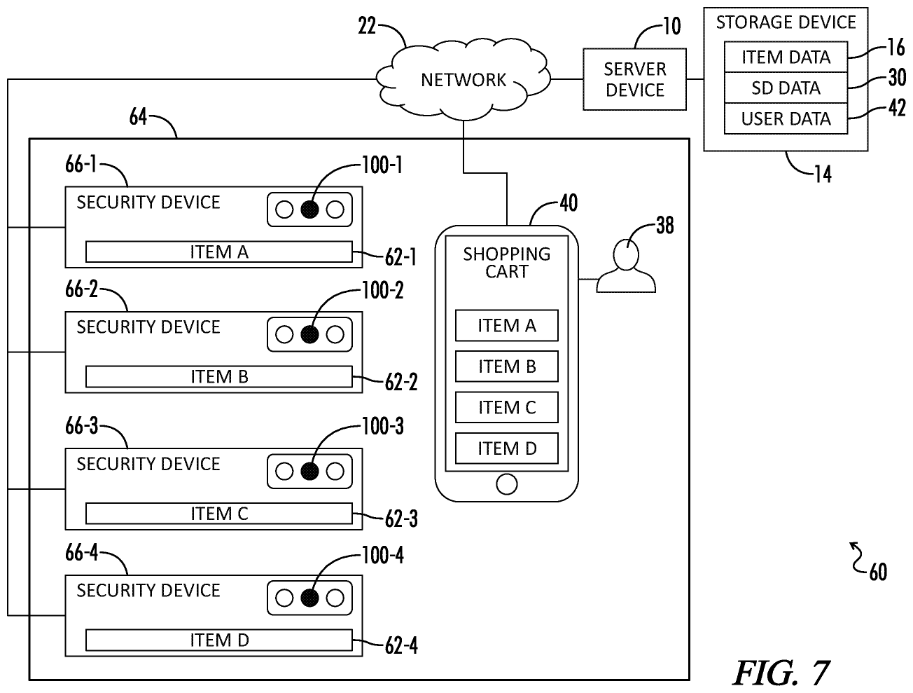

FIG. 7 is a block diagram of the system 60 according to another embodiment. For purposes of illustration, assume that four items 62-1-62-4 are of interest to the user 38, each of which is secured by a corresponding security device 66-1-66-4. Each item 62 is located relatively far apart from each other within the retail location 64, such as on different floors of the retail location 64. In this embodiment, the mobile device 40 offers the user 38 a shopping cart mode, wherein the user 38 can place an item 62 into an electronic (i.e., virtual) shopping cart by indicating such desire to the mobile device 40. For example, while in proximity to the item 62-1, the mobile device 40 receives data that uniquely identifies the item 62-1, such as the unique item ID 24-1 (FIG. 3). The mobile device 40 may display information related to the item 62-1, such as an item description, cost, or the like, and provide a shopping cart control which, if selected by the user 38, enters the item 62-1 into an electronic shopping cart associated with the user 38. Assume that the user 38 selects the shopping cart control to place the item 62-1 into the shopping cart. The mobile device 40 communicates the unique item ID 24-1 to the server device 10, along with data indicating an intent to purchase the item 62-1 by the user 38, such as an indication that the user 38 selected the shopping cart control.

In response to the receipt of the data indicating the intent by the user 38 to purchase the item 62-1, the server device 10 sends data to the security device 66-1 directing the security device 66-1 to indicate that the item 62-1 is unavailable for purchase by any other user 38. In response, the security device 66-1 visually indicates that the item 62-1 is unavailable for purchase, such as by activating a light 100-1. The light 100-1 may comprise a certain color, such as yellow, that reflects the unavailable status of the item 62-1. It is apparent that other visual indicators, such as the display of one or more words, or audible indicators, could be used to convey such information.

As the user 38 adds each item 62-2, 62-3, and 62-4 to the shopping cart, a similar process takes place and each security device 66-2, 66-3, and 66-4 activates a visual indicator, such as lights 100-2-100-4, respectively. During the period of time that the lights 100 are activated, attempts by other users 38 to purchase the respective item will be rejected.

If, after a predetermined period of time, such as one hour for example, the user 38 has not finalized the transaction and purchased the respective items 62, the server device 10 may remove the items 62 from the shopping cart associated with the user 38, and send a communication to each security device 66 directing the security devices 66 to indicate that the items 62 are available for purchase. In response, the security devices 66 may deactivate the lights 100-1-100-4, and may activate other lights to indicate the availability of the items 62 for purchase.

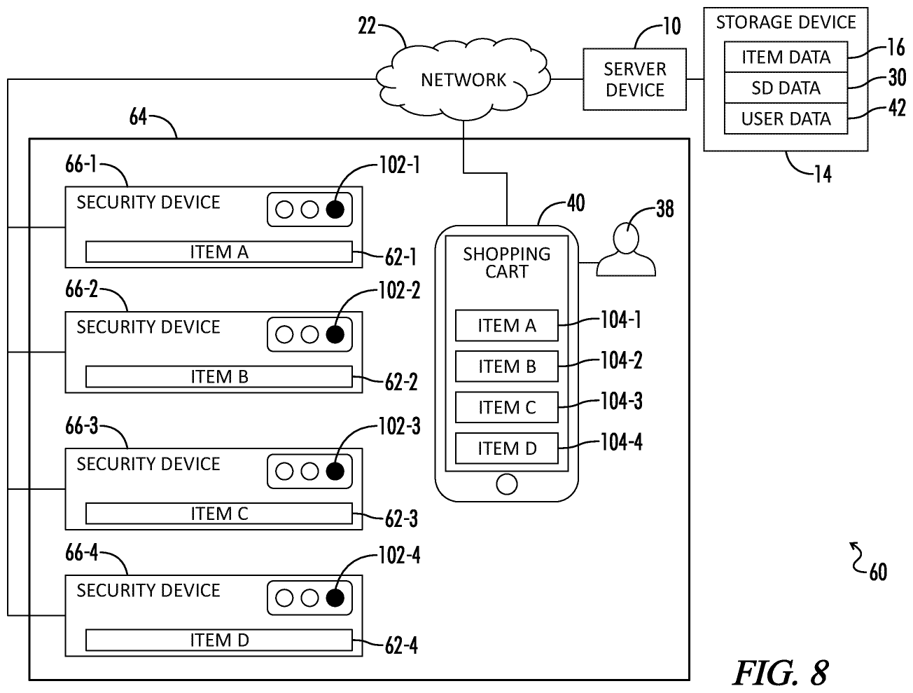

Assume, however, that the user 38 selects a purchase control (not illustrated) on the mobile device 40 to purchase the items 62. FIG. 8 is a block diagram of the system 60 illustrated in FIG. 7 after a point in time at which the user 38 has purchased the items 62. After the server device 10 receives suitable payment authorization for the items 62, as discussed for example with respect to FIG. 3, the server device 10 may send a communication to the security devices 66 that indicates the items 62 are now permanently unavailable to any other user 38. The security devices 66 may activate corresponding visual indicators, such as lights 102, that indicate the respective items 62-1-62-4 have been purchased.

In this embodiment, however, the mobile device 40 does not automatically direct the security devices 66 to unsecure the corresponding items 62. Rather, the mobile device 40 displays item controls 104-1-104-4 (generally, item controls 104) that correspond to the purchased items 62-1-62-4. The item controls 104 may visually indicate their respective correspondence to the items 62. For example, the item controls 104 may comprise words that identify each item 62. Alternatively, the item controls 104 may comprise images, or icons, that represent the respective item 62.

The user 38 moves in proximity to a desired item 62, such as the item 62-1, and selects the corresponding item control 104-1. In response, the mobile device 40 communicates a release message to the server device 10. The server device 10 sends data to the security device 66-1 to unsecure the item 62-1. In response, the security device 66-1 unsecures the item 62-1. In an alternative embodiment, the mobile device 40 may communicate the release message to the security device 66-1, which may then communicate the release message to the server device 10, and subsequently receive from the server device 10 the data to unsecure the item 62-1, or may unsecure the item 62-1 without receiving a message from the server device 10.

Over a period of time, the user 38 repeats this process, such that over the period of time, the mobile device 40 sends a consecutive plurality of release messages to the server device 10 directly, or via corresponding security devices 66. In this manner, the user 38 may cause the release of the respective security device 66 at a point in time when the user 38 is in physical proximity of the respective security device 66, rather than at a time when the user 38 is not near the security device 66, and thereby risk another user 38 taking the corresponding item 62.

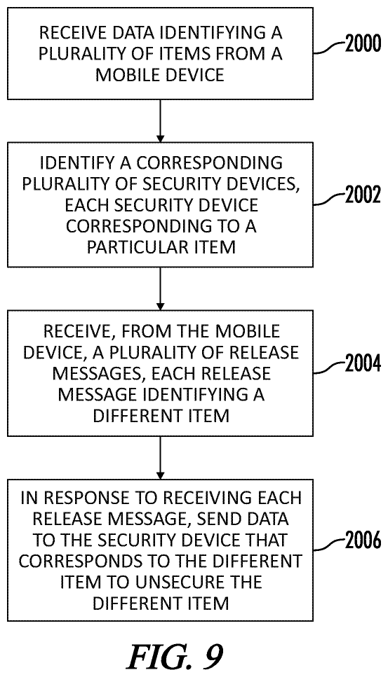

FIG. 9 is a flowchart of a method for releasing items 62 according to one embodiment, and will be discussed in conjunction with FIG. 8. The server device 10 receives data identifying the items 62-1-62-4 over a period of time (block 2000). For each such item 62, the server device 10 identifies the corresponding security device 66-1-66-4 (block 2002). After the user 38 has purchased the items 62, the server device receives a plurality of release messages, each release message identifying a different item 62-1-62-4 (block 2004). In response to receiving each release message, the server device 10 sends data to the security device 66-1-66-4 that corresponds to the different item 62-1-62-4 to unsecure the different item 62-1-62-4 (block 2006).

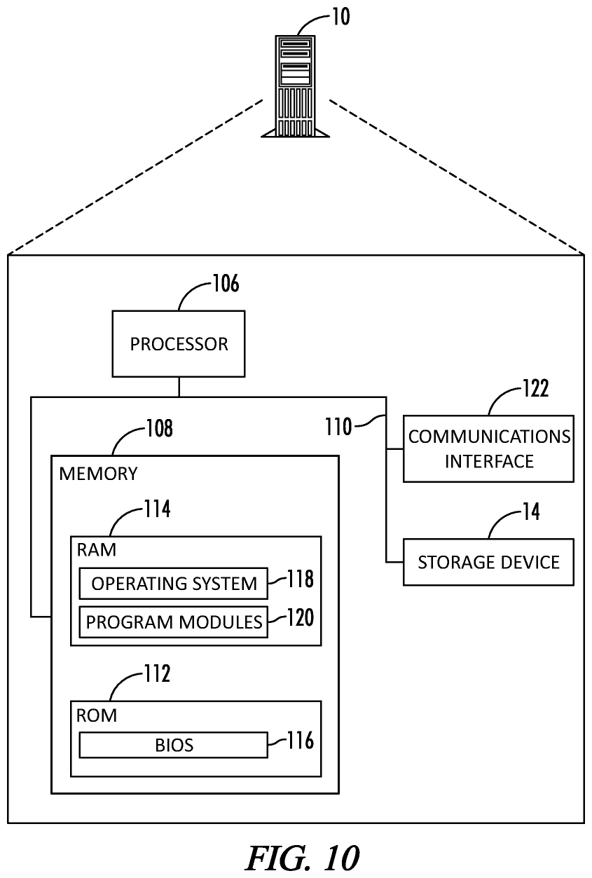

FIG. 10 is a block diagram illustrating a server device 10 according to one embodiment. The server device 10 may comprise any computing or processing device capable of implementing the functionality described herein, such as a work station, a desktop, or the like. The server device 10 includes a processor 106, a system memory 108, and a system bus 110. The system bus 110 provides an interface for system components including, but not limited to, the system memory 108 and the processor 106. The processor 106 can be any commercially available or proprietary processor. Dual microprocessors and other multi-processor architectures may also be employed as the processor 106.

The system bus 110 may be any of several types of bus structures that may further interconnect to a memory bus (with or without a memory controller), a peripheral bus, and/or a local bus using any of a variety of commercially available bus architectures. The system memory 108 may include non-volatile memory 112 (e.g., read only memory (ROM), erasable programmable read only memory (EPROM), electrically erasable programmable read only memory (EEPROM), etc.) and/or volatile memory 114 (e.g., random access memory (RAM)). A basic input/output system (BIOS) 116 may be stored in the non-volatile memory 112, and can include the basic routines that help to transfer information between elements within the server device 10. The volatile memory 114 may also include a high-speed RAM, such as static RAM for caching data.

The server device 10 may further include the storage device 14, which may comprise, for example, an internal hard disk drive (HDD) (e.g., enhanced integrated drive electronics (EIDE) or serial advanced technology attachment (SATA)), HDD (e.g., EIDE or SATA) for storage, flash memory, or the like. The storage device 14 and other drives, associated with computer-readable and computer-usable media, provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the operating environment, and further, that any such media may contain computer-executable instructions for performing methods disclosed herein.

A number of modules can be stored in the storage device 14 and in the volatile memory 114, including an operating system 118 and one or more program modules 120, which may implement, at least in part, the functionality described herein in whole or in part. It is to be appreciated that the embodiments can be implemented with various commercially available operating systems 118 or combinations of operating systems 118.

All or a portion of the embodiments may be implemented as a computer program product stored on a transitory or non-transitory computer-usable or computer-readable storage medium, such as the storage device 14, which includes complex programming instructions, such as complex computer-readable program code, configured to cause the processor 106 to carry out the steps described herein. Thus, the computer-readable program code can comprise software instructions for implementing the functionality of the embodiments described herein when executed on the processor 106. The processor 106, in conjunction with the program modules 120 in the volatile memory 114, may serve as a control system for the server device 10 that is configured to, or adapted to, implement the functionality described herein.

The server device 10 may also include a communications interface 122 suitable for communicating with the network 22 and the mobile device 40. As discussed previously, the functionality described herein may be implemented on a single server device 10 or functionality may be divided over multiple server devices 10, depending on a desired implementation.

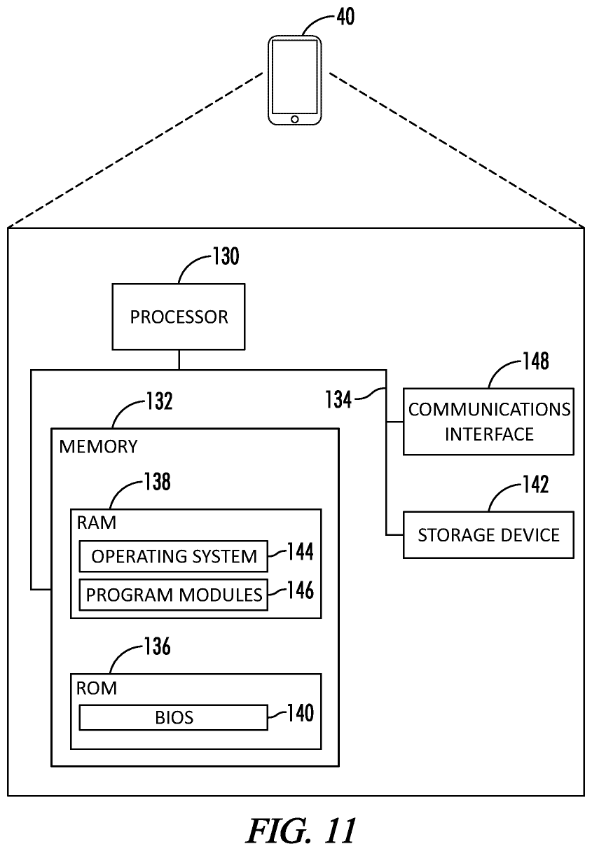

FIG. 11 is a block diagram illustrating a mobile device 40 according to one embodiment. The mobile device 40 may comprise any mobile computing or processing device capable of implementing the functionality described herein. Non-limiting examples of the mobile device 40 comprise a smartphone or computer tablet, such as an Apple® iOS-based smartphone or tablet, or Android®-based smartphone or tablet, or a laptop computer. The mobile device 40 includes a processor 130, a system memory 132, and a system bus 134. The system bus 134 provides an interface for system components including, but not limited to, the system memory 132 and the processor 130. The processor 130 can be any commercially available or proprietary processor. Dual microprocessors and other multi-processor architectures may also be employed as the processor 130.

The system bus 134 may be any of several types of bus structures that may further interconnect to a memory bus (with or without a memory controller), a peripheral bus, and/or a local bus using any of a variety of commercially available bus architectures. The system memory 132 may include non-volatile memory 136 (e.g., read only memory (ROM), erasable programmable read only memory (EPROM), electrically erasable programmable read only memory (EEPROM), etc.) and/or volatile memory 138 (e.g., random access memory (RAM)). A basic input/output system (BIOS) 140 may be stored in the non-volatile memory 136, and can include the basic routines that help to transfer information between elements within the mobile device 40. The volatile memory 138 may also include a high-speed RAM, such as static RAM for caching data.

The mobile device 40 may further include a storage device 142, which may comprise, for example, an internal hard disk drive (HDD) or solid state memory. A number of modules can be stored in the storage device 142 and in the volatile memory 138, including an operating system 144 and one or more program modules 146, which may implement, at least in part, the functionality described herein in whole or in part. In one embodiment, the retailer 12 provides a program module 146 for download to the mobile device 40 for implementing at least portions of the functionality described herein.

All or a portion of the embodiments may be implemented as a computer program product stored on a transitory or non-transitory computer-usable or computer-readable storage medium, such as the storage device 142, which includes complex programming instructions, such as complex computer-readable program code, configured to cause the processor 130 to carry out the steps described herein. Thus, the computer-readable program code can comprise software instructions for implementing the functionality of the embodiments described herein when executed on the processor 130. The processor 130, in conjunction with the program modules 146 in the volatile memory 138, may serve as a control system for the mobile device 40 that is configured to, or adapted to, implement the functionality described herein.

The mobile device 40 may also include a communications interface 148 suitable for communicating with the network 22 and the server device 10. The communications interface 148 may implement any number of communications technologies, such as, for example, WiFi™, Bluetooth®, Zigbee®, cellular data, and the like.

While for purposes of illustration, the security device 66 has generally been discussed in the context of a container, it will be apparent that the security device 66 may comprise any structure capable of securing and unsecuring the item 62, and could include, by way of non-limiting example, a “smart” tether, such as a cable or lock that may be releasably coupled to the item 62.

Those skilled in the art will recognize improvements and modifications to the preferred embodiments of the present disclosure. All such improvements and modifications are considered within the scope of the concepts disclosed herein and the claims that follow.

What is claimed is:

1. A server device, comprising:
a first communications interface configured to communicate with a network;
a first processor device coupled to the first communications interface; and
a security device, comprising:
a releasable barrier for securing an item;
a second communications interface configured to communicate with the network; and
a second processor coupled to the second communications interface and the releasable barrier;
wherein the first processor device is configured to:
receive, via the first communications interface from a mobile device, data identifying an item;
identify the security device that secures the item;
determine that a payment for the item has been authorized; and
send, via the first communications interface, data to the security device directing the security device to unsecure the item; and
wherein the security device is configured to:
receive, via the second communications interface, the data from the first processor device directing the security device to release the releasable barrier to unsecure the item; and
in response to the data, release the releasable barrier.
